(19) United States
(12) Patent Application Publication
(10) Pub. No.: US 2018/0063551 A1
(43) Pub. Date: Mar. 1, 2018

(54) APPARATUS AND METHODS FOR FRAME INTERPOLATION

(71) Applicant: GoPro, Inc., Carlsbad, CA (US)

(72) Inventors: Balineedu Chowdary Adsumilli, San Francisco, CA (US); Ryan Lustig, Encinitas, CA (US); Aaron Staranowicz, Carlsbad, CA (US)

(21) Appl. No.: 15/251,980

(22) Filed: Aug. 30, 2016

(51) Int. Cl. H04N 19/80; H04N 19/43; H04L 12/26

(52) U.S. Cl. CPC H04N 19/80; H04N 19/172; H04L 43/16; H04N 19/43

(57) ABSTRACT

Apparatus and methods for generating interpolated frames in digital image or video data. In one embodiment, the interpolation is based on a hierarchical tree sequence. At each level of the tree, an interpolated frame may be generated using original or interpolated frames of the video, such as those closest in time to the desired time of the frame to be generated. The sequence proceeds through lower tree levels until a desired number of interpolated frames, a desired video length, a desired level, or a desired visual quality for the video is reached. In some implementations, the sequence may use different interpolation algorithms (e.g., of varying computational complexity or types) at different levels of the tree. The interpolation algorithms can include for example those based on frame repetition, frame averaging, motion compensated frame interpolation, and motion blending.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the Disclosure

The present disclosure relates generally to processing of image and/or video content, and more particularly in one exemplary aspect to interpolating frames of video.

### Description of Related Art

Video content may include a bitstream characterized by a number of frames that are played back at a specified frame rate. In some video applications, it may be desirable to add frames to video content. Video frames may be added to, for example, convert video content from one frame rate to another. For instance, video may be streamed over the Internet at a low frame rate, and then converted to a higher frame rate during decoding by a video player for presentation to a viewer. As another example, video content may be converted between cinematic, PAL, NTSC, HDTV, and slow motion frame rates during encoding. Video frames may also be added to improve visual quality of the video content, or even supplement missing or corrupted data or to compensate for certain types of artifacts.

Frame interpolation techniques may be used to generate new frames from original frames of the video content. Frame interpolation involves creating a new frame from two (three, four, five, or more) discrete frames of video; for example, as between Frame t and Frame t+1 (t and t+1 indicating two discrete points of time in this example). Any number of new frames (e.g., 1 to 1000 frames) may be generated between the two or more discrete frames as shown in FIG. 1A and FIG. 1B. In general, a new frame is created at Frame t+α, where α is between 0 and 1. Typically, Frame t+α is created based solely on pixel information from Frame t and Frame t+1 as shown in FIG. 1B. Conventional techniques of frame interpolation include frame or field repetition, temporal filtering or blending, and motion estimation and compensation.

Depending on the value of α, the interpolation of video frames may impact the visual quality of the video sequence, or may unnecessarily use computational time and resources. For example, when the difference in the value of α between two frames is large (e.g., 0.5), the motion depicted by the two frames may be irregular and may not be as smooth as desired. When the difference in the value of α between two frames is small (e.g., 0.01), the visual difference between the two frames may be indistinguishable, and generation of these two very similar frames may add computational time and complexity.

Prior art techniques generate “interpolated” frames from just t and t+1 (i.e., not using intermediary frames); when other time intervals are needed, such techniques weight the source frames to obtain the desired interpolated frame (which is, among other disabilities, computationally intensive). Such weighting process can also result in a choppy of visually undesirable interpolated video, thereby reducing user experience significantly.

Thus, improved solutions are needed for frame interpolation which, inter alia, produce a sequence of images with smooth motion flow without unnecessarily creating nearly indistinguishable images (and exacting the associated computational, temporal, and/or other resource “price” for processing of such largely unnecessary images or frames.

### SUMMARY

The present disclosure satisfies the foregoing needs by providing, inter alia, methods and apparatus for generating images or frames, such as via use of a hierarchical tree-based interpolation sequence.

In a first aspect of the disclosure, a method of frame interpolation is disclosed. In one embodiment, the method includes: obtaining at least a first source frame and a second source frame; generating a first interpolated frame using at least the first source frame and the second source frame; and generating a second interpolated frame using at least the first source frame and the first interpolated frame.

In one variant, the method further includes generating an interpolated frame in response to determining that a visual difference between consecutive frames is noticeable to a viewer.

In a second variant, the first interpolated frame is generated using a first interpolation algorithm, and the second interpolated frame is generated using a second interpolation algorithm that is different from the first. For instance the different algorithms may be more or less useful for more or less complex or computationally intensive interpolations, and may include e.g., frame repetition, frame averaging, motion compensated frame interpolation, and motion blending algorithms.

In a second aspect, another method of frame interpolation is disclosed. In one embodiment, the method includes: generating a first interpolated frame by performing a first level of interpolation of at least a first source frame and a second source frame; and generating a second interpolated frame by performing another level of interpolation using at least an interpolated frame from a level immediately preceding the another level, and a frame at least two levels preceding the another level.

In one variant, the interpolated frame from the level immediately preceding the another level comprises the first interpolated frame, and the frame at least two levels preceding the another level comprises the first source frame or the second source frame.

In another variant, the frame at least two levels preceding the another level comprises the first interpolated frame.

In a third variant, generating the second interpolated frame includes selection of at least two frames associated with respective times that are closest to a desired time for the second interpolated frame, the selected at least two frames including the interpolated frame from the level immediately preceding the another level, and the frame at least two levels preceding the another level. The second interpolated frame is generated using the selected at least two frames.

In another aspect, yet another method of frame interpolation is disclosed. In one embodiment, the method includes: obtaining a first frame associated with a first time; obtaining a second frame associated with a second time; and generating an interpolated frame associated with a third time between the first time and the second time, the interpolated frame being generated using at least two frames associated with times close (or closest) to the third time. The two frames may include for example: (i) the first frame or the second frame and a previously generated interpolated frame, or (ii) two previously generated interpolated frames.

In one variant, the interpolated frame is generated in response to, or based on, determining that a visual difference between the two frames is noticeable to a viewer. For example, such determination may include: identifying a set of pixels having a largest optical flow between the two frames; determining a time difference between the two frames; and determining that a combination of the largest optical flow and the time difference is greater than a threshold.

In a further aspect, an apparatus configured for frame interpolation is disclosed. In one embodiment, the apparatus includes one or more processors configured to execute one or more computer programs, and a non-transitory computer readable medium comprising the one or more computer programs with computer-readable instructions that are configured to, when executed by the one or more processors, cause the application of an interpolation sequence (such as, e.g., a hierarchical tree-based interpolation sequence) in order to generate interpolated frames for insertion into a video stream.

In yet another aspect, a non-transitory computer readable medium comprising a plurality of computer readable instructions is disclosed. In one exemplary embodiment, the instructions are configured to, when executed by a processor apparatus, cause application of a hierarchical tree-based interpolation sequence to generate interpolated frames for insertion into a video stream.

In a further aspect, an integrated circuit (IC) device configured for image or video data processing is disclosed. In one embodiment, the IC device is fabricated using a silicon-based semiconductive die and includes logic configured to implement power-efficient video frame or image interpolation. In one variant, the IC device is a system-on-chip (SoC) device with multiple processor cores and selective sleep modes, and is configured to activate only the processor core or cores (and/or other SOC components or connected assets) when needed to perform the foregoing frame or image interpolation, yet otherwise keep the cores/components in a reduced-power or sleep mode.

In yet a further aspect, a method of optimizing (e.g., reducing) resource consumption associated with video data processing is disclosed. In one embodiment, the method includes selectively performing certain ones of one or more processing routines based at least on information relating to whether a user can visually perceive a difference between two frames of data.

In one variant, the resource relates to electrical power consumption within one or more IC devices used to perform the video interpolation processing. In another variant, the resource relates to temporal delay in processing (i.e., avoiding significant, or user-perceptible latency). In yet another variant, the resource is an optimization of two or more resources, such as e.g., the foregoing electrical power and temporal aspects.

In a further embodiment, the method of optimization is based at least on data relating to one or more evaluation parameters associated with the video data. For example, in one variant, the degree of motion reflected in the video data portion of interest is used as a basis for interpolation processing allocation (e.g., little subject motion between successive source frames would generally equate to comparatively fewer hierarchical levels of the above-referenced interpolation “tree”). In another variant, data relating to the capture and/or display frame rates is used as a basis of interpolation processing allocation, such as where computational assets allocated to frame interpolation would be comparatively lower at slower display frame rates.

In another aspect, a data structure useful in, e.g., video data processing is disclosed. In one embodiment, the data structure includes a hierarchical or multi-level “tree” of interpolated digital video data frames, levels of the tree stemming from other ones of interpolated video data frames.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1A is a graphical illustration of a prior art approach for generating interpolated frames at a symmetric temporal spacing with respect to source video frames, during video encoding.

FIG. 1B is a graphical illustration of a prior art approach to generating a plurality of interpolated frames at various non-symmetric spacings with respect to the source frames using weighting.

FIG. 2 is a logical block diagram of an exemplary implementation of video data processing system according to the present disclosure.

FIG. 3 is a functional block diagram illustrating the principal components of one implementation of the processing unit of the system of FIG. 2.

FIG. 4 is graphical representation of a hierarchical interpolation “tree” sequence, in accordance with some implementations.

FIG. 5 is a graphical representation of another implementation of a hierarchical tree sequence, wherein each level triples the number of interpolated frames generated.

FIG. 6 is a logical flow diagram showing an exemplary method for generating interpolated frames of video content in accordance with some implementations of the disclosure.

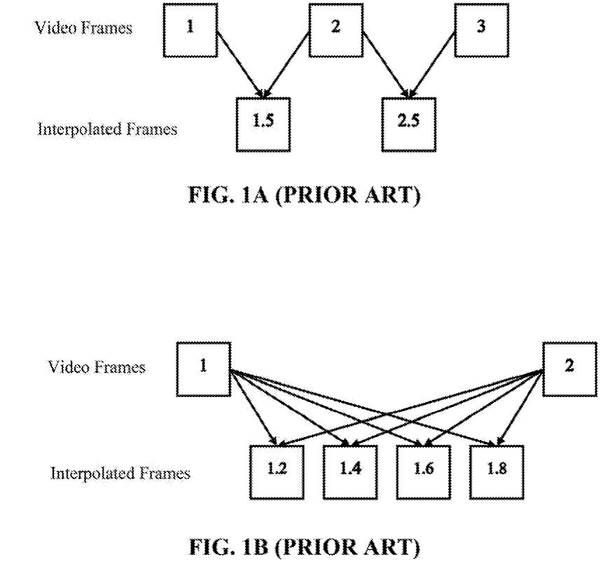

All Figures disclosed herein are © Copyright 2016 GoPro Inc. All rights reserved.

### DETAILED DESCRIPTION

Implementations of the various aspects of the present technology will now be described in detail with reference to the drawings, which are provided as illustrative examples so as to enable those skilled in the art to practice the technology. Notably, the figures and examples below are not meant to limit the scope of the present disclosure to a single implementation or implementations, but other implementations are possible by way of interchange of or combination with some or all of the described or illustrated elements. Wherever convenient, the same reference numbers will be used throughout the drawings to refer to same or like parts.

In one salient aspect, the present disclosure provides improved apparatus and methods for generating interpolated frames, in one implementation through use of a hierarchical tree-based interpolation sequence. Source video content includes a number of source frames or images that are played back at a specified frame rate. As noted supra, in some video applications, it may be desirable to increase the number of frames in video content so as to achieve one or more objectives such as reduced perceivable motion artifact.

Generation of interpolated frames may be computationally intensive, such as when a large number of frames is to be generated. Thus, there is a need for a scalable and/or selectively implementable interpolation sequence for generating interpolated frames. The interpolation sequence may be configured to apply different interpolation algorithms of varying computational complexity at different levels of the tree-based interpolation sequence. The interpolation algorithms may include (but are not limited to): (i) frame repetition, (ii) frame averaging, (iii) motion compensated frame interpolation (including, e.g., block-based motion estimation and pixel-wise motion estimation), and (iv) motion blending (including, e.g., Barycentric interpolation, radial basis, K-nearest neighbors, and inverse blending).

As used herein, “frame repetition” refers generally to interpolating frames by simply repeating frames, such as is described generally within “Low-Resolution TV: Subjective Effects of Frame Repetition and Picture Replenishment,” to R. C. Brainard et al., Bell Labs Technical Journal, Vol 46, (1), January 1967, incorporated herein by reference in its entirety.

As used herein, “frame averaging” refers generally to interpolating frames based on averaging (or otherwise weighting) pixel values between frames, such as is described generally within “Low Complexity Algorithms for Robust Video frame rate up-conversion (FRUC) technique,” to T. Thaipanich et al., IEEE Transactions on Consumer Electronics, Vol 55, (1): 220-228, February 2009; “Inter Frame Coding with Template Matching Averaging,” to Suzuki et al., in IEEE International Conference on Image Processing Proceedings (2007), Vol (III): 409-412; and “Feature-Based Image Metamorphosis,” to Beier et al., in Computer Graphics Journal, Vol 26, (2), 35-42, July 1992, each of the foregoing incorporated herein by reference in its entirety.

As used herein, “motion compensated” refers generally to frame interpolation based on motion compensation between frames, such as is described generally within “Block-based motion estimation algorithms—a survey,” to M. Jakubowski et al., Opto-Electronics Review 21, no. 1 (2013): 86-102; “A Low Complexity Motion Compensated Frame Interpolation Method,” to Zhai et al., in IEEE International Symposium on Circuits and Systems (2005), 4927-4930, each of the foregoing incorporated herein by reference in its entirety.

As used herein, “motion blending” refers generally to frame interpolation based on blending motion compensation information between frames, such as is described generally within “Computer vision: algorithms and applications,” to R. Szeliski, Springer Science & Business Media (2010); “A Multiresolution Spline with Application to Image Mosaics.,” to Burt et al., in ACM Transactions on Graphics (TOG), vol. 2, no. 4 (1983): 217-236; “Poisson Image Editing,” to Pérez et al., in ACM Transactions on Graphics (TOG), vol. 22, no. 3, (2003): 313-318, each of the foregoing incorporated herein by reference in its entirety.

In some implementations, the frame interpolation methodologies described herein may be employed at a decoder. In one or more implementations, frame interpolation or other described processes may be performed prior to or during encoding.

To generate new frames of video content using the hierarchical tree-based interpolation sequence, two frames of video at Frame t and Frame t+1 are used to create a first interpolated frame Frame t+0.5, which represents the first node in the first level of the tree. At the second level of the tree, a second interpolated frame Frame t+0.25 is generated from Frame t and Frame t+0.5, and a third interpolated frame Frame t+0.75 is generated from Frame t+0.5 and Frame t+1. At each level of the tree, an interpolated frame may be generated using original or interpolated frames of the video that are closest in time to the desired time of the frame that is to be generated. The interpolation sequence proceeds through lower levels of the tree in such a manner until a desired number of interpolated frames, a desired video length, a desired level, or a desired visual quality for the video is reached.

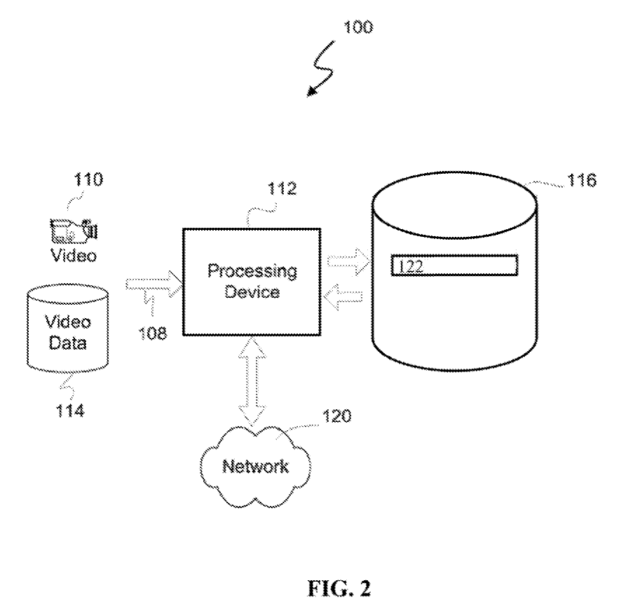

FIG. 2 is a block diagram illustrative of on exemplary configuration of a video processing system 100 configured to generate interpolated frames from video content. In the embodiment of FIG. 2, a processing unit 112 receives a source video stream 108 (e.g., sequences of frames of digital images and audio). The source video stream may originate from a variety of sources including a video camera 110 and a data storage unit 114. The source video stream 108 may be conveyed by a variety of means including USB, DisplayPort, Thunderbolt, or IEEE-1394 compliant cabling, PCI bus, HD/SDI communications link, any 802.11 standard, etc. The source video stream 108 may be in a compressed (e.g., MPEG) or uncompressed form. If the source video stream 108 is compressed, it may be decompressed to an uncompressed form. Also shown is a data storage unit 116 configured to store a video stream 122 produced from the source video stream 108 and interpolated frames generated from the source video stream 108. A network 120 (e.g., the Internet) may be used to carry a video stream to remote locations.

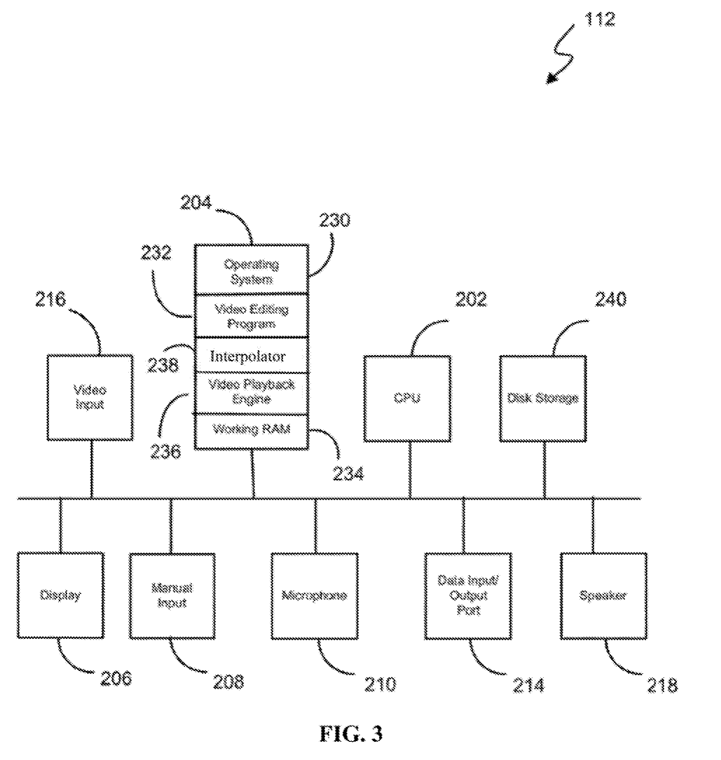

FIG. 3 is a block diagram illustrating the principal components of the processing unit 112 of FIG. 2 as configured in accordance with an exemplary implementation. In this exemplary implementation, the processing unit 112 comprises a processing device (e.g., a standard personal computer) configured to execute instructions for generating interpolated frames of a video stream. Although the processing unit 112 is depicted in a “stand-alone” arrangement in FIG. 2, in alternate implementations the processing unit 112 may be incorporated into a video recorder or video camera or part of a non-computer device such as a media player such as a DVD or other disc player. In other implementations, the processing unit 112 may be incorporated into a smartphone, a tablet computer, a phablet, a smart watch, a portable computer, and/or other device configured to process video content.

As shown in FIG. 3, the processing unit 112 includes a central processing unit (CPU) 202 adapted to execute a multi-tasking operating system 230 stored within system memory 204. The CPU 202 may in one variant be rendered as a system-on-chip (SoC) comprising, inter alia, any of a variety of microprocessor or micro-controllers known to those skilled in the art, including digital signal processor (DSP), CISC, and/or RISC core functionality, whether within the CPU or as complementary integrated circuits (ICs). The memory 204 may store copies of a video editing program 232 and a video playback engine 236 executed by the CPU 202, and also includes working RAM 234.

It will also be appreciated that the processing unit 112, as well as other components within the host apparatus of FIG. 2, may be configured for varying modes of operation which have, relative to other modes: (i) increased or decreased electrical power consumption; (ii) increased or decreased thermal profiles; and/or (iii) increased or decreased speed or execution performance, or yet other such modes. In one implementation, a higher level logical process (e.g., software or firmware running on the SoC or other part of the apparatus) is used to selectively invoke one or more of such modes based on current or anticipated use of the interpolation sequences described herein; e.g., to determine when added computational capacity is needed—such as when a high frame rate and inter-frame motion are present), and activate such capacity anticipatorily (or conversely), place such capacity to “sleep” when the anticipated demands are low.

It is also contemplated herein that certain parametric values relating to host device and/or SoC operation may be used as inputs in determining appropriate interpolation sequence selection and execution. For example, in one such implementation, approaching or reaching a thermal limit on the SoC (or portions thereof) may be used by supervisory logic (e.g., software or firmware) of the apparatus to invoke a less computationally intensive interpolation sequence (or regime of sequences) until the limit is obeyed. Similarly, a “low” battery condition may invoke a more power-efficient regime of interpolation so as to conserve remaining operational time. Moreover, multiple such considerations may be blended or combined together within the supervisory logic; e.g., where the logic is configured to prioritize certain types of events and/or restrictions (e.g., thermal limits) over other considerations, such as user-perceptible motion artifact or video “choppiness”, yet prioritize user experience over say a low battery warning. Myriad other such applications will be recognized by those of ordinary skill given the present disclosure.

In the illustrated configuration the CPU 202 communicates with a plurality of peripheral equipment, including video input 216. Additional peripheral equipment may include a display 206, manual input device 208, microphone 210, and data input/output port 214. Display 206 may be a visual display such as a cathode ray tube (CRT) monitor, a liquid crystal display (LCD) screen, LED/OLED monitor, capacitive or resistive touch-sensitive screen, or other monitors and displays for visually displaying images and text to a user. Manual input device 208 may be a conventional keyboard, keypad, mouse, trackball, or other input device for the manual input of data. Microphone 210 may be any suitable microphone for providing audio signals to CPU 202. In addition, a speaker 218 may be attached for reproducing audio signals from CPU 202. The microphone 210 and speaker 218 may include appropriate digital-to-analog and analog-to-digital conversion circuitry as appropriate.

Data input/output port 214 may be any data port for interfacing with an external accessory using a data protocol such as RS-232, USB, or IEEE-1394, or others named elsewhere herein. Video input 216 may be via a video capture card or may be any interface that receives video input such as a camera, media player such as DVD or D-VHS, or a port to receive video/audio information. In addition, video input 216 may consist of a video camera attached to data input/output port 214. The connections may include any suitable wireless or wireline interfaces, and further may include customized or proprietary connections for specific applications.

In the exemplary implementation, the system (e.g., as part of the system application software) includes a frame interpolator and combiner function 238 configured to generate interpolated frames from a source video stream (e.g., the source video stream 108), and combine the interpolated frames with the source video stream to create a new video stream. A user may view the new “composite” video stream using the video editing program 232 or the video playback engine 236. The video editing program 232 and/or the video playback engine 236 may be readily available software with the frame interpolator 238 incorporated therein. For example, the frame interpolator 238 may be implemented within the framework of the ADOBE PREMIER video editing software.

A source video stream (e.g., the source video stream 108) may be retrieved from the disk storage 240 or may be initially received via the video input 216 and/or the data input port 214. The source video or image stream may be uncompressed video data or may be compressed according to any known compression format (e.g., MPEG or JPEG). In some implementations, the video stream and associated metadata may be stored in a multimedia storage container (e.g., MP4, MOV) such as described in detail in U.S. patent application Ser. No. 14/622,427, entitled “APPARATUS AND METHODS FOR EMBEDDING METADATA INTO VIDEO STREAM” filed on Oct. 22, 2015, incorporated herein by reference in its entirety, and/or in a session container (e.g., such as described in detail in U.S. patent application Ser. No. 15/001,038, entitled “METADATA CAPTURE APPARATUS AND METHODS” filed on Jan. 19, 2016, incorporated herein by reference in its entirety).

Mass storage 240 may be, for instance, a conventional read/write mass storage device such as a magnetic disk drive, floppy disk drive, compact-disk read-only-memory (CD-ROM) drive, digital video disk (DVD) read or write drive, solid-state drive (SSD) or transistor-based memory or other computer-readable memory device for storing and retrieving data. The mass storage 240 may consist of the data storage unit 116 described with reference to FIG. 2, or may be realized by one or more additional data storage devices. Additionally, the mass storage 240 may be remotely located from CPU 202 and connected thereto via a network (not shown) such as a local area network (LAN), a wide area network (WAN), or the Internet (e.g., “cloud” based).

In the exemplary embodiment, the manual input 208 may receive user input characterizing desired frame rate (e.g., 60 frames per second (fps)) and/or video length of the new video stream to be generated from a source video stream. The manual input 208 may communicate the user input to the processing device 112.

In an alternate embodiment, the desired frame rate and/or video length of the new video stream to be generated from the source video stream may be incorporated into the source video stream as metadata. The processing device 112 reads the metadata to determine the desired frame rate and/or video length for the new video stream.

In yet another embodiment, the desired frame rate and/or length may be dynamically determined or variable in nature, such as where logic (e.g., software or firmware) operative to run on the host platform evaluates motion (estimation) vector data present from the encoding/decoding process of the native codec (e.g., MPEG4/AVC, H.264, or other) to determine an applicable frame rate. Specifically, temporal portions of the subject matter of the video content may have more or less relative motion associated therewith (whether by motion of objects within the FOV, or motion of the capture device or camera relative to the scene, or both), and hence be more subject to degradation of user experience and video quality due to a slow frame rate than other portions. Hence, the depth of the hierarchical interpolation tree may be increased or decreased accordingly for such portions. Moreover, as described in greater detail below, the types and/or configuration of the algorithms used at different portions of the hierarchical tree depending on, e.g., inter-frame motion or complexity.

In the illustrated implementation, the processing device 112 generates interpolated frames from the source video stream using a hierarchical tree-based interpolation sequence. At each level of the tree, an interpolated frame may be generated using original or interpolated frames of the video that are closest in time to the desired time of the frame that is to be generated. The interpolation sequence proceeds through the levels of the tree until a desired number of interpolated frames, a desired video length, a desired level, or a desired visual quality for the video is reached.

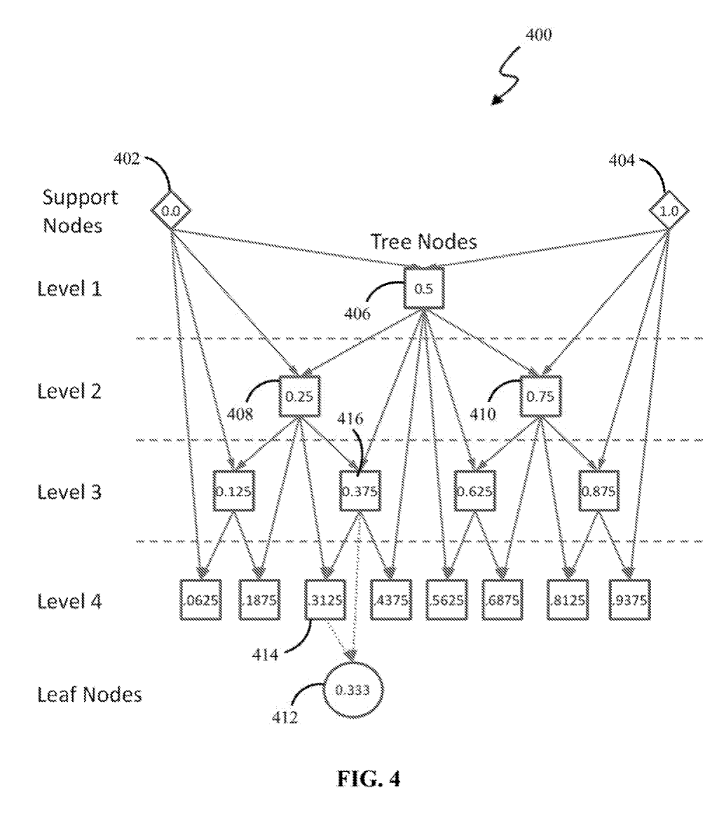

FIG. 4 shows a diagram 400 illustrating the hierarchical tree-based interpolation sequence. In the illustrated diagram 400, the support nodes 402 and 404 represent original frames Frame 0.0 and Frame 1.0 of the source video stream. Frame 0.0 may be associated with a time, e.g., t=0. Frame 1.0 may be associated with a time, e.g., t=1.0. Frame 0.0 and Frame 1.0 are interpolated to generate an interpolated frame Frame 0.5 represented by tree node 406 at level 1 of the tree. Frame 0.5 may be associated with a time, e.g., t=0.5, that is halfway between the times of Frame 0.0 and Frame 1.0.

At level 2 of the interpolation sequence, two interpolated frames Frame 0.25 and Frame 0.75 represented by tree nodes 408 and 410, respectively, may be generated. Frame 0.25 is generated using original Frame 0.0 and interpolated Frame 0.5 and associated with a time, e.g., t=0.25, that is half-way between Frame 0.0 and Frame 0.5. Frame 0.75 is generated using interpolated Frame 0.5 and original Frame 1.0 and associated with a time, e.g., t=0.75, that is halfway between Frame 0.5 and Frame 1.0.

At level 3 of the interpolation sequence, new frames are generated using original frames of the source video and interpolated frames generated during levels 1 and 2 of the interpolation sequence. Each new frame is generated using original or interpolated frames of the video that are closest in time to the desired time of the new frame that is to be generated. As shown in FIG. 4, Frame 0.125 is generated using Frame 0.0 and Frame 0.25. Frame 0.375 is generated using Frame 0.25 and Frame 0.5. Frame 0.625 is generated using Frame 0.5 and Frame 0.75. Frame 0.875 is generated using Frame 0.75 and Frame 1.0.

At level 4 of the interpolation sequence, new frames are generated using original frames of the source video and interpolated frames generated during the previous levels of the interpolation sequence. Each new frame is generated using original or interpolated frames of the video that are closest in time to the desired time of the new frame that is to be generated. As shown in FIG. 4, Frame 0.0625 is generated using Frame 0.0 and Frame 0.125. Frame 0.1875 is generated using Frame 0.125 and Frame 0.25. Frame 0.3125 is generated using Frame 0.25 and Frame 0.375. Frame 0.4375 is generated using Frame 0.375 and Frame 0.5. Frame 0.5625 is generated using Frame 0.5 and Frame 0.625. Frame 0.6875 is generated using Frame 0.625 and Frame 0.75. Frame 0.8125 is generated using Frame 0.75 and Frame 0.875. Frame 0.9375 is generated using Frame 0.875 and Frame 1.0.

The interpolation sequence proceeds through levels of the tree in the manner described until a desired number of interpolated frames, a desired video length, a desired level, or a desired visual quality for the video is reached. In general, a frame of any leaf node (α ∈ [0,1]) of the interpolation tree may be generated using frames from previous levels of the tree. Each frame is associated with a time, and the frames that are closest in time to the new frame to be generated is used for interpolation, rather than simply using the original frames of video content (which may be further away in time from the new frame).

For example, in a tree with four levels as shown in FIG. 4, if a new frame represented by leaf node 412 is desired at time t=0.333, a new Frame 0.333 is generated from Frame 0.3125 represented by node 414 and Frame 0.375 represented by node 416. When the original frames of the video content, e.g., Frame 0.0 and Frame 1.0 represented by support nodes 402 and 404 are strictly used, the motion in the interpolated frames may appear to jump from one interpolated frame to the next. Frames represented by tree nodes 414 and 416 that are closer to the leaf node 412 are more visually similar and more spatially related than the frames of the support nodes 402 and 404. Interpolating using the frames of the closest nodes may generate a new frame with smoother motion flow.

If consecutive frames having a small value of α, e.g., α=0.01, is desired, rather than generating new frames Frame t+0.01 and Frame t+0.02 from scratch, an existing leaf node is used instead. The visual difference between Frame t+0.01 and Frame t+0.02 may be nearly indistinguishable, and thus the frames may be generated only when necessary.

To determine whether to generate a new interpolated frame, the interpolator of the exemplary implementation identifies the cluster of pixels with the largest optical flow, p_{f}, between the two frames closest in time to the desired interpolated frame. Next, the time difference between the two frames is computed (t_{diff}=t₁−t₂). If p_{f}*t_{diff}>τ, where τ is some threshold, then the new interpolated frame may be generated. The threshold τ indicates when the visual difference between consecutive interpolated frames is noticeable to the viewer.

In some embodiments, “different” interpolation algorithms may be used to generate interpolated frames at different levels of the tree. As used herein, the term “different” includes, without limitation, both (i) use of heterogeneous interpolation algorithms and/or sequences, and (ii) use of homogeneous algorithms, yet which are configured with different sequence parameters or settings. As but one example, the complexity of the interpolation algorithm may decrease as levels are added to the tree. To illustrate, frames at levels 1 and 2 of the tree may be generated using a high complexity interpolation algorithm such as a motion-compensated frame interpolation algorithm. Frames at level 3 of the tree may be generated using a medium complexity interpolation algorithm such as a basic blending/blurring algorithm. The difference between frames at level 3 may be low, and the low complexity of basic blending/blurring may be sufficient in generating interpolated frames while maintaining a high visual quality. Frames at level 4 and higher may be generated using a low complexity interpolation algorithm such as a frame repetition/replication algorithm.

Typically, when a high quality interpolated frame is required, high amounts of computational resources are used to achieve this quality. However, there may be situations when high quality is not a priority, and low-computation low-quality frame interpolation is preferred. The decision whether to use a high or low computation interpolation algorithm may be based on hardware trade-off and is usually not possible to make in real time.

The hierarchical tree-based interpolation sequence may be used to (1) hierarchically define the intermediate frames at different levels, and (2) apply different interpolation algorithms to different levels. The criteria for whether a level corresponds to a low, mid, or high complexity algorithm may depend on a trade-off between the desired quality and the computational complexity. Due to the hierarchical tree structure, the interpolation sequence may provide fast implementations for higher levels (due to smaller visual differences) and therefore may allow the trade-offs to be made in real time.

In addition, the hierarchical tree structure is scalable for videos with asymmetric motion attributes, i.e., varying amounts of motion speed from frame to frame (acceleration/deceleration) in one segment of the video versus another. For example, the hierarchical tree structures for a source video comprising frames Frame 0, Frame 0.5, and Frame 1 may reach level 2 between Frame 0 and Frame 0.5, while reaching level 5 between Frame 0.5 and Frame 1.

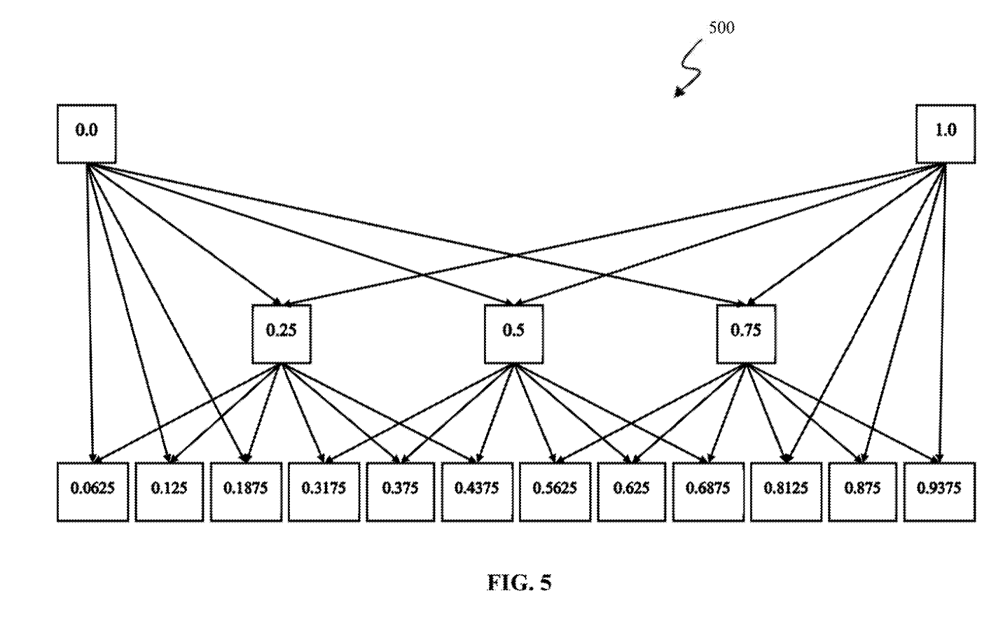

While FIG. 4 illustrates a tree structure where each level of the tree doubles the number of interpolated frames generated, other implementations may apply a tree structure where each level more than doubles the number of interpolated frames generated. For example, FIG. 5 illustrates another implementation of a hierarchical tree sequence where each level triples the number of interpolated frames generated.

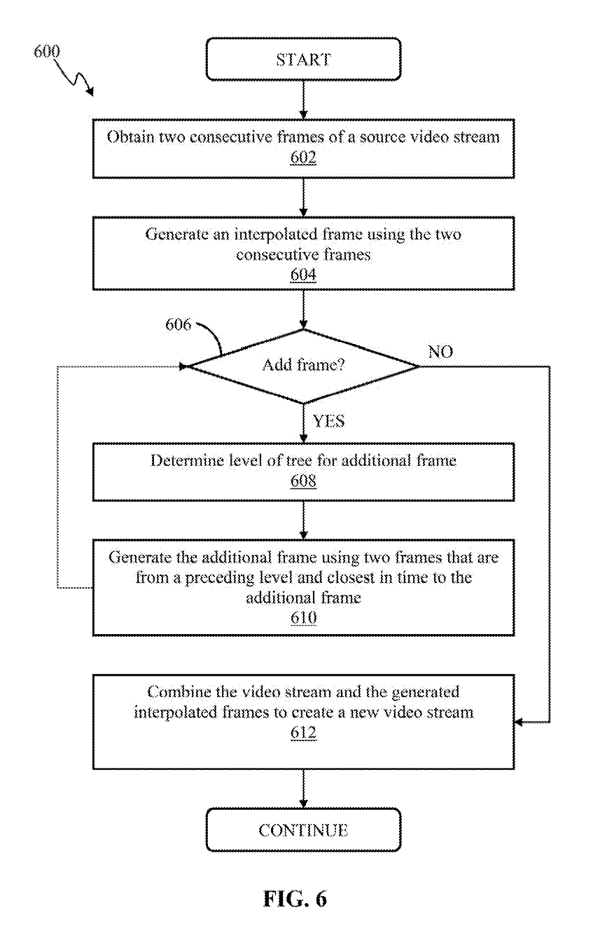

FIG. 6 illustrates a method for generating interpolated frames of video content in accordance with some implementations of the present disclosure. The operations of method 600 are intended to be illustrative. In some implementations, method 600 may be accomplished with one or more additional operations not described and/or without one or more operations discussed. Additionally, the order in which the operations of method 600 are illustrated in FIG. 6 and described below is not intended to be limiting.

In some implementations, method 600 may be implemented in one or more processing devices, such as the SoC previously described herein (e.g., with one or more digital processor cores), an analog processor, an ASIC or digital circuit designed to process information, an analog circuit designed to process information, a state machine, and/or other mechanisms for electronically processing information. The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of the method 600.

Operations of the method 600 may also be effectuated by two or more devices and/or computerized systems (including those described with respect to FIGS. 2 and 3) in a distributed or parallel processing fashion. For instance, in one variant contemplated herein comprises use of multiple processing devices (e.g., digital processor cores on a common SoC) each performing respective portions of the hierarchical tree sequence of FIGS. 4 or 5. Alternatively, the computations may be divided up among several discrete ICs (whether on the same or different host devices), such as in a computational “farm”. The computations may also be divided by type (e.g., those of differing algorithms referenced above may be performed most efficiently on respective different types of processing platforms or devices). Myriad other

At operation 602, two consecutive frames of a source video stream may be obtained. In some implementations, the source video stream may include a sequence of high resolution images (e.g., 4K, 8K, and/or other resolution) captured and encoded by a capture device and/or obtained from a content storage entity.

At operation 604, an interpolated frame may be generated using the two consecutive frames. The interpolated frame may be generated using a high complexity interpolation algorithm such as a motion-compensated frame interpolation algorithm for a high visual quality.

At operation 606, the method 600 includes determining whether to add a new frame. A new frame may be added until a desired number of interpolated frames, a desired video length, a desired level, or a desired visual quality for the video is reached. A new frame may also be added when the visual difference between consecutive interpolated frames is noticeable to the viewer as described above.

At operation 608, a level of the hierarchical interpolation tree where the additional frame is to be added may be determined. This determination may be made based on the hierarchical tree structure to be applied to the interpolation sequence. Examples of hierarchical tree structures include those described with reference to FIGS. 4 and 5.

At operation 610, the additional frame is generated using two frames that are from a preceding level of the hierarchical tree structure and closest in time to the additional frame. The additional frame may be generated using an interpolation algorithm corresponding to the level of the tree where the frame is to be added. The interpolation algorithms include (but are not limited to): frame repetition, frame averaging, motion compensated frame interpolation (including, e.g., block-based motion estimation and pixel-wise motion estimation), and motion blending (including, e.g., Barycentric interpolation, radial basis, K-nearest neighbors, and inverse blending). The complexity of the interpolation algorithm may decrease as levels are added to the tree.

At operation 612, the video stream and the generated interpolated frames are combined to create a new video stream. To combine the video stream and the generated interpolated frames, the interpolated frames may be inserted between the two consecutive frames of the source video stream in a sequence corresponding to time stamps associated with the interpolated frames. The combined video stream and interpolated frames may be rendered, encoded, stored in a storage device, and/or presented on a display to a user.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the terms “computer”, “computing device”, and “computerized device”, include, but are not limited to, personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “connection”, “link”, “transmission channel”, “delay line”, “wireless link” means a causal link between any two or more entities (whether physical or logical/virtual), which enables information exchange between the entities.

As used herein, the terms “integrated circuit”, “chip”, and “IC” are meant to refer, without limitation, to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

As used herein, the term “camera” may be used to refer to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A method of digital frame interpolation, the method comprising:
obtaining a first source frame and a second source frame;
generating a first interpolated frame using at least the first source frame and the second source frame; and
generating a second interpolated frame using at least the first source frame and the first interpolated frame.

2. The method of claim 1, wherein the first source frame and the second source frame comprise consecutive frames of digital video data.

3. The method of claim 1, further comprising generating a third interpolated frame using at least the first interpolated frame and the second source frame.

4. The method of claim 1, further comprising:
generating a third interpolated frame using at least the first source frame and the second interpolated frame; and
generating a fourth interpolated frame using at least the first interpolated frame and the second interpolated frame.

5. The method of claim 1, wherein each of the first source frame, the second source frame, the first interpolated frame, and the second interpolated frame are associated with a respective time, and the method further comprises:
selecting at least two frames from among the first source frame, the second source frame, the first interpolated frame, and the second interpolated frame, the selected two at least frames associated with respective times that are closest to a desired time for a third interpolated frame; and
generating the third interpolated frame using the selected at least two frames.

6. The method of claim 1, further comprising generating an interpolated frame in response to a determination that a visual difference between consecutive frames is perceivable to a viewer upon rendering on a display device.

7. The method of claim 6, wherein the determination that the visual difference between consecutive frames is perceivable to the viewer comprises:
identifying a set of pixels having a largest optical flow between the consecutive frames;
determining a time difference between the consecutive frames; and
determining that a combination of the largest optical flow and the time difference is greater than a prescribed threshold.

8. The method of claim 1, wherein the first interpolated frame is generated using at least a first interpolation algorithm, and the second interpolated frame is generated using at least a second interpolation algorithm different than the first interpolation algorithm.

9. A computer-implemented method of digital video data frame interpolation, the method comprising:
generating a first interpolated frame by at least performing a first level of interpolation of a first source frame and a second source frame; and
generating a second interpolated frame by at least performing another level of interpolation using: (i) an interpolated frame from a level immediately preceding the another level within a hierarchical tree, and (ii) a frame at least two levels preceding the another level within the tree.

10. The method of claim 9, wherein the first source frame and the second source frame comprise consecutive frames of a digital video stream.

11. The method of claim 9, wherein the interpolated frame from the level immediately preceding the another level comprises the first interpolated frame, and the frame at least two levels preceding the another level comprises at least one of the first source frame or the second source frame.

12. The method of claim 9, wherein the frame at least two levels preceding the another level comprises the first interpolated frame.

13. The method of claim 9, wherein the generating the second interpolated frame comprises:
selecting at least two frames associated with respective times that are temporally proximate to a desired time for the second interpolated frame, the selected at least two frames comprising the interpolated frame from the level immediately preceding the another level and the frame at least two levels preceding the another level; and
generating the second interpolated frame using at least the selected two frames.

14. The method of claim 9, wherein the second interpolated frame is generated in response to determining that a visual difference between consecutive frames is noticeable to a viewer.

15. The method of claim 14, wherein the determining that the visual difference between consecutive frames is noticeable to the viewer comprises:
identifying a set of pixels having a largest optical flow between the consecutive frames;
determining a time difference between the consecutive frames; and
determining that a combination of the largest optical flow and the time difference is greater than a threshold.

16. The method of claim 9, wherein each level of interpolation is performed using a different interpolation algorithm.

17. A computerized method of digital frame interpolation, the method comprising:
obtaining a first frame associated with a first time;
obtaining a second frame associated with a second time; and
generating an interpolated frame associated with a third time between the first time and the second time, the interpolated frame being generated using at least two frames associated with respective times within a prescribed temporal proximity to the third time, the at least two frames comprising either: (i) the first frame or the second frame and a previously generated interpolated frame, or (ii) two previously generated interpolated frames.

18. The method of claim 17, wherein the interpolated frame is generated in response to determining that a difference between the at least two frames would be visually noticeable to a viewer.

19. The method of claim 18, wherein the determining that the difference between the two frames would be noticeable to the viewer comprises:
identifying a set of pixels having a largest optical flow between the two frames;
determining a time difference between the two frames; and
determining that a combination of the largest optical flow and the time difference is greater than a threshold.

20. The method of claim 17, wherein the interpolated frame is generated using a first interpolation algorithm, and the previously generated interpolated frame is generated using a second, different interpolation algorithm.
